(19) United States
(12) Patent Application Publication
(10) Pub. No.: US 2002/0184646 A1
(43) Pub. Date: Dec. 5, 2002

(54) Method and apparatus for time shifting of broadcast content that has synchronized web content

(75) Inventor: William P. Lord, Fishkill, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/874,421

(22) Filed: Jun. 5, 2001

(51) Int. Cl. H04N 7/173; G06F 15/16; H04N 7/16

(52) U.S. Cl. 725/109; 709/217; 725/89; 725/135

(57) ABSTRACT

A system and method for providing a synchronized replay of a television program and the corresponding web content are provided. The system includes a means for establishing a web connection to the web server providing the corresponding web content; a means for recording the television program selected by a user; a means for storing the television program selected by said user and the corresponding web content from the web server; a means for reproducing the stored television program and the web content responsive to the television program in a synchronized manner; and, a means of control configured to receive a request to record the television program selected by the user, wherein the control means is operative for controlling the recording means to initiate the recording of the television program, while initiating the recording of the web content responsive to the television program. In response to a user's request, the system establishes a web connection to the corresponding web server, then one of the television program selected by the user and the corresponding web content downloaded from the web server are synchronized and stored in a memory medium for subsequent replay.

### BACKGROUND OF THE INVENTION

1. Field of Invention

The present invention relates to a personal video recording system, and in particular, to a method and apparatus for providing a time-shifted display of a previously recorded television broadcast with the corresponding enhanced TV Web simulcast.

2. Description of the Invention

The development of computerized information resources, such as the “Internet,” allows users to communicate with various servers to retrieve electronic information that is unavailable in a normal electronic medium. A server is typically a remote computer system that is accessible over the Internet. The function of a server is to scan and search for information sources in response to a user's request. As such, electronic information is presented to a user in hypertext in which text, images, sounds, and action are linked together in complex associations that permit the user to browse through related topics.

A user (or client) can link to the server utilizing the functionality provided by a hypertext transfer protocol (HTTP). Active within the client is a process known as a “browser,” which establishes the connection to the server and presents information to the user in the form of HTTP responses (or web pages). The World Wide Web (WWW) includes all servers adhering to this protocol, and these servers are accessible by users (or clients) via a Universal Resource Locator (URL). Hence, one can gain access to Internet services by specifying Universal Resource Locators that have two basic components: a protocol to be used and an object pathname. For example, the Universal Resource Locator address, “http://www.nbc.com” specifies a hypertext transfer protocol (“http”) and a pathname of the server (“www.nbc.com”). The server name is associated with a unique numeric value (TCP/IP address).

One form of electronic information known as “enhanced TV” is becoming very popular. In this feature, the content of a particular web page is synchronized with a television broadcast. For example, web pages from the ABC.COM website related to Monday Night Football are active only during the broadcast of “ABC's Monday Night Football.” During the football game, the ABC.COM site allows all users browsing the content of “Monday Night Football Enhanced TV pages” to guess what type of play the offense might run in the next play. These guesses from the viewers are collected until the next play is initiated, then, once the play is completed, responses are tallied and scores are updated. A top ten list of all people who guessed plays most correctly can be displayed. This synchronization of the Web game and the real game are performed by the staff at ABC.COM by transmitting Web updates as they watch the game.

However, if a user chooses to record a particular TV broadcast program for later viewing, the user is unable to take part in the program enhancement that was simulcast on the Web page of the TV broadcaster. Accordingly, there is a need to provide synchronized replay of both the TV broadcast and the content of the corresponding web page.

### SUMMARY OF THE INVENTION

The present invention relates to a method and apparatus for providing a synchronized replay of a previously recorded television program and the corresponding enhanced web simulcast.

The present invention provides a method of recording and replaying a television program transmitted from a TV broadcaster and the corresponding web content from the TV broadcaster's server by performing the following steps of: receiving a request to record a television program selected by a user; establishing a web connection to the TV broadcaster's web server; downloading the web content responsive to the television program; and, storing the television program selected by said user and the downloaded web content from the web server in a memory for later display.

The present invention provides an apparatus that is capable of providing a synchronized replay of a television program and the corresponding web content and includes: a means for establishing a web connection to the web server providing the corresponding web content; a means for recording the television program selected by a user; a means for storing a television program selected by the user and the corresponding web content from the web server; a means for reproducing the stored television program and the web content that is synchronized to the stored television program; and, a control means configured to receive a request to record the television program selected by the user, and for initiating a recording of the web content synchronized to the television program.

### BRIEF DESCRIPTION OF THE DRAWINGS

The above and other features and advantages of the present invention will become more apparent from the following detailed description when taken in conjunction with the accompanying drawings, in which:

FIG. 1 illustrates a simplified block diagram of a first embodiment of the present invention;

FIG. 2 illustrates a simplified plain-view block diagram of the first embodiment shown in FIG. 1;

FIG. 3 illustrates a circuit diagram of a personal video recorder according to the first embodiment of the present invention;

FIG. 4 illustrates a circuit diagram of a computer system according to an embodiment of the present invention;

FIG. 5 is a flow chart illustrating the operation steps of the embodiment of the present invention;

FIG. 6 illustrates a simplified block diagram of a second exemplary embodiment of the present invention;

FIG. 7 illustrates a circuit diagram of the second exemplary embodiment of the present invention;

FIG. 8 illustrates a simplified block diagram of a third exemplary embodiment of the present invention; and, FIG. 9 illustrates a circuit diagram of the third exemplary embodiment of the present invention.

### Detailed Description of the Preferred Embodiment

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

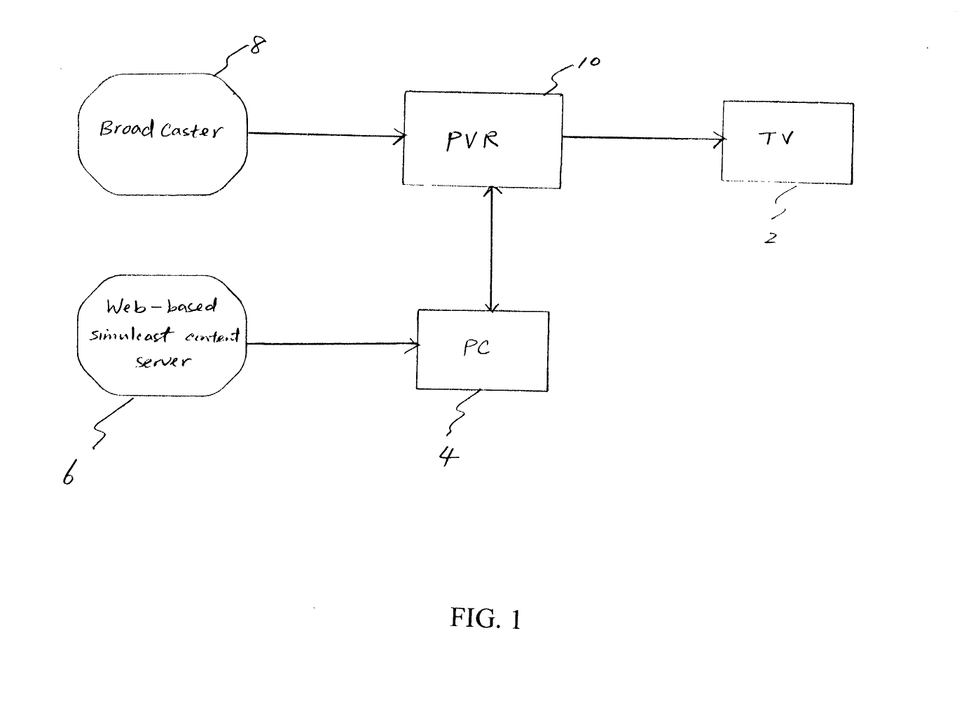

FIG. 1 illustrates a first embodiment of the inventive system capable of providing synchronized replay of a particular TV broadcast with the corresponding web page content. In the preferred embodiment, a personal video recorder (PVR) 10 is coupled to receive TV broadcast programs from a conventional TV broadcaster 8 to display the received TV programs to a television set 2. The PVR 10 is also coupled to a personal computer system 4, which is coupled to receive the Internet content from a particular web server 6. Here, a computer system 4 can be implemented by utilizing any conventional computer system. In the operation mode, the PVR 10 records the TV program selected by a user and simultaneously activates the computer system 4 to make a web connection to the web server providing the “enhanced program” to the public. Here, the web connection can be also made to a proxy, or unaffiliated third party providing the interactive capability. For simplicity, the term “enhanced program” will refer to the web content provided by a particular server to allow a user to participate in various interactive features. Thereafter, in the replay mode, both “enhanced programs” simulcast with the recorded TV program are replayed in a synchronized manner so that the user will be able to participate interactively with the previously recorded TV program.

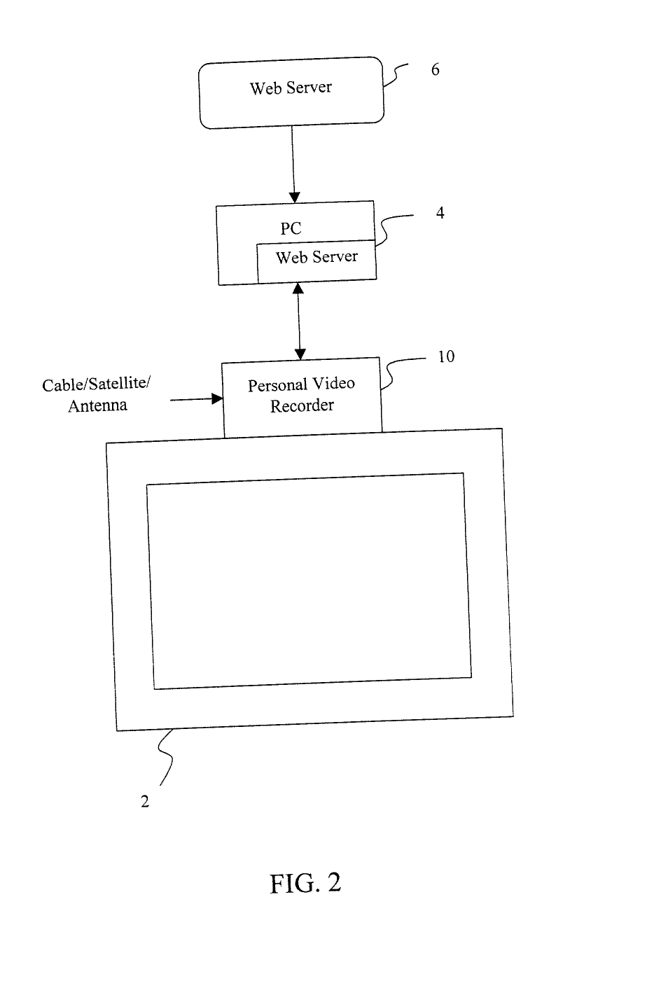

FIG. 2 depicts a pictorial representation of the PVR 10 in accordance with the first embodiment shown in FIG. 1. As shown in FIG. 2, the PVR 10 is adapted to receive a stream of TV programs through a variety of medium, including a cable service provider, a satellite dish, and a conventional RF broadcast. The function of PVR 10 according to the present invention is to record a desired TV program (i.e., Monday Night Football) transmitted by a particular broadcaster (i.e., ABC™ television) as well as the simulcast web content from the same broadcaster's web server, so that a replay of the recorded program can be realized later along with the related web content that was transmitted from the broadcaster's server. In this manner, a viewer watching the recorded program at a later time can still enjoy the benefit of various features offered by the broadcaster's server. To achieve this, the PVR 10 activates the computer system 4 in communication with the broadcaster's web server 6 to record the corresponding web pages during the recording of a program selected by a user. As such, both the desired TV program and the synchronized web content are recorded in the PVR 10. The web content downloaded by the computer system 4 is stored in a memory medium and assigned to a filename designated by the user, or generated by the PVR 10. It is noted that the location of storage for the related web content can be either in the PVR 10 or in the computer system 4. Meanwhile, the recorded TV program and the related web content are time stamped and synchronization points are added for subsequent replay purposes. Thereafter, the PVR 10 retrieves the stored programs and the related web content from a storage medium and re-synchronizes them back together during a time-shifted playback mode.

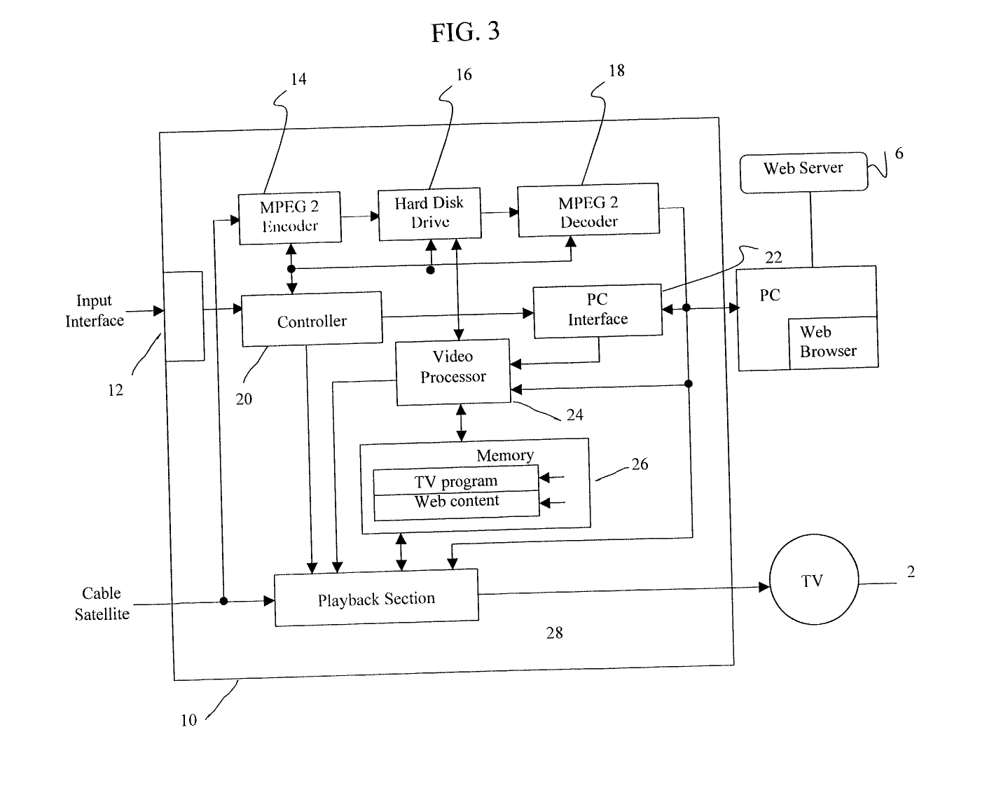

FIG. 3 illustrates an exemplary PVR 10 in greater detail according to the embodiment of the present invention. The PVR 10 includes an input interface (i.e., IR sensor) 12, MPEG-2 encoder 14, hard disk drive 16, MPEG-2 decoder, controller 20, PC interface 22, video processor 24, and memory 26, and playback section 28. It is noted that MPEG encoder/decoder may comply with other MPEG standards, i.e., MPEG-1, MPEG-2, MPEG-4, and MPEG-7. The controller 20 overseas the overall operations of the detection device 10, including a view mode, record mode, play mode, and other modes that are common in a personal video recording system.

During a view mode, the controller 20 causes the incoming signals from the cable service provider to be demodulated and processed by the video processor 24 for display on the television set 2. The video processor 24 tunes to a user-selected channel from incoming signals and converts the selected signal to a baseband television signal that is suitable for display on the television set 2. The incoming signals may be a digital signal, an analog signal, or Internet protocol (IP) packets. In a normal record mode, the controller 20 causes the MPEG-2 encoder 14 to receive incoming television signals delivered from a satellite, cable or television broadcasts and converts the received TV signals to an MPEG format for storage on the hard disk driver 16. In a normal playing mode, the controller 20 causes the hard disk driver 16 to stream the recorded television signals to an MPEG-2 decoder, which in turn transmits the decoded TV signals to be transmitted to the television set 2 via the play back section 28.

In the event that a user makes a request to record a specific program along with the related web content for time-shifted replay, the controller 20 causes the program selected by the user from the TV broadcaster 8 to be stored in the memory 26. This request signal can be activated using a button in a remote control device (not shown) and transmitted to the PVR 10 via the input interface 12. At the same time, the controller 20 transmits a request to the viewing software (i.e., web browser) of the PC 4 to make a web connection and download the web information from the server of the same TV broadcaster, then stores the downloaded web content in the memory 26 of the PVR 10. Alternatively, the web content can be stored in the PC 4. It is noted that any number of commercially or publicly available browsers can be utilized in various implementations in accordance with the preferred embodiment of the present invention. For example, a browser such as Netscape™ (a trademark of Netscape, Inc.) can be utilized in accordance with a preferred embodiment of the present invention to provide the functionality specified under HTTP. Prior to storing in the memory 26, both the recorded TV program and the downloaded web content are time stamped so that re-synchronized displacing of both types of information can realized later. Thereafter, if a user wishes to replay the recorded program along with the simulcast Internet content, the controller 20 causes the playback section 28 to retrieve both the TV program and the related Internet content from the memory 26. At this time, the PC 4 assumes the role of the broadcaster's web server by extracting time stamps from the TV content. Upon receiving a time stamp, the PC 4 retrieves any web content from memory 26 that has the same time stamp. Hence, the PC 4 serves this retrieved web content to the browser running on the PC 4 for playback.

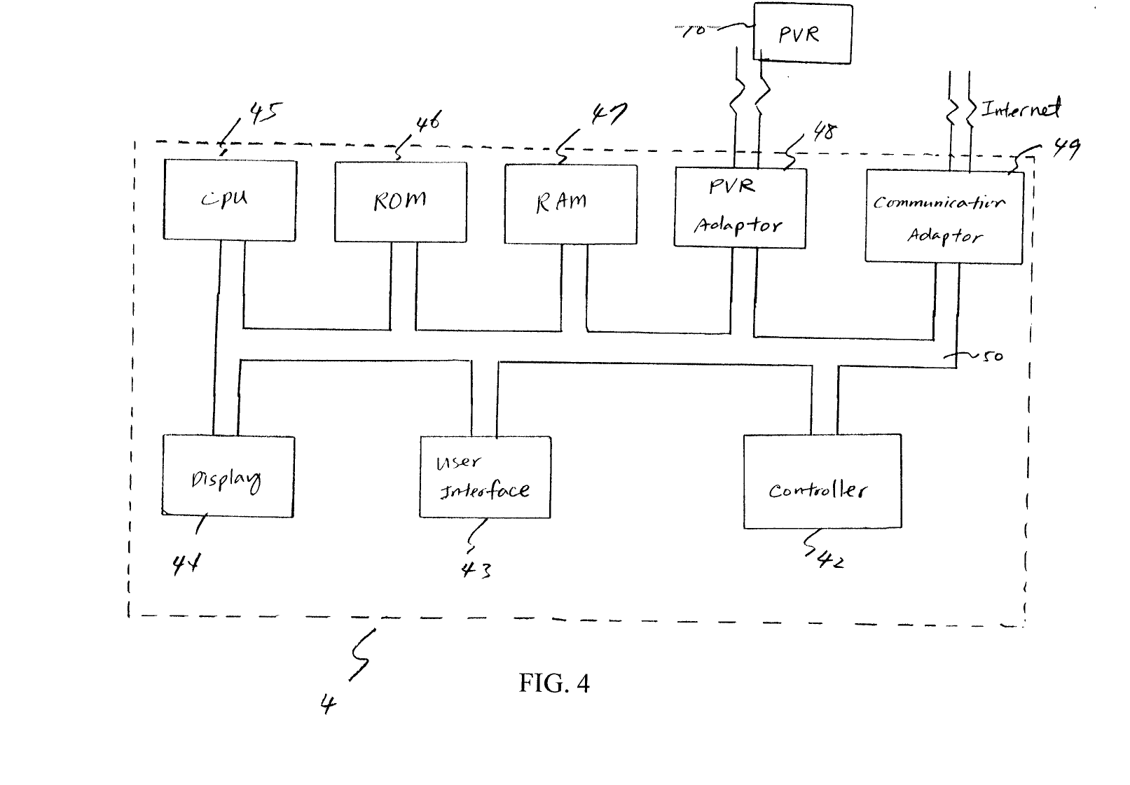

FIG. 4 depicts a representative hardware of the computer system 4 illustrated in FIG. 1. Basically, the computer system 4 includes a central processing unit (CPU) 45, such as a conventional microprocessor, and a number of other units interconnected via system bus 50, including a read only memory (ROM) 46, a display unit 44, PVR adapter 48 for connecting the PVR 10 to the computer system 10, a random access memory (RAM) 47, a communication adapter 49 for interfacing with the Internet, and a controller 42 for controlling the overall operation of the entire computer system 4. Upon receiving a request to download a particular Internet content from the PVR 10, the computer system 4 downloads the requested content and forwards them back to the PVR 10. It is noted that those skilled in the art will appreciate that the hardware depicted in FIG. 3 may vary for specific applications.

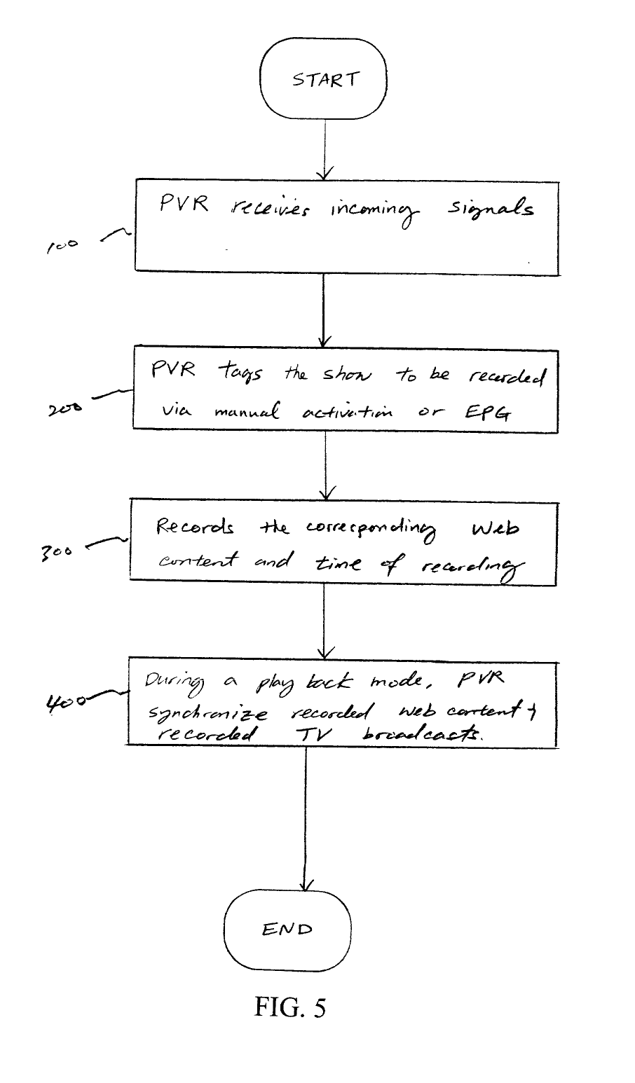

FIG. 5 depicts a flow diagram that shows steps utilized to carry out the detection and storage of the TV programs and the related web content in accordance with a preferred embodiment of the present invention. In step 100, the PVR 10 receives incoming signals from a cable service provider, antenna or satellite service. Upon receiving a user's request to record a particular TV program and the corresponding enhanced TV Web simulcast that is synchronized with the TV program, the PVR sends a signal to the PC to set up for caching (or recording) all events and content of the specified Web cast in step 200. Alternatively, a request to download the Internet content can be programmed automatically using a well-known electronic program guide (EPG) protocol. An EPG is a standard application designed to aid the viewer in the navigation of and selection from broadcast materials available in a digital TV environment. As such, the EPG provides information about each program and includes programming characteristics, such as the channel number, program title, start time, end time, elapsed time, time remaining, rating (if available), topic, theme, and a brief description of the program's content. Using the EPG features, the PVR 10 can be programmed to automatically activate the web browser of the PC 4 to download and store the Internet content from a specific web server if the incoming signals indicate that a particular program provides the enhanced TV web simulcast.

Next, in step 300, the PVR 10 starts recording and time stamping the exact time of the TV broadcast and the web content. To accomplish this, the PC 4 initiates a Web connection, which may include emulating some user interaction, to the site supplying the simulcast and proceeds to record all events and the related content and notes with a time stamp when each event or piece of content arrives. After the recording session ends, the PVR 10 signals the PC 4 to stop recording and save all information to a specified file. The saved information can be stored in the memory 26 of the PVR 10, or alternatively, stored in a memory medium of the PC 4.

Thereafter, in step 400, if the user decides to watch the recorded broadcast, the PVR 10 initiates a playback of the selected program by sending a playback command w/filename to the PC 4. The PVR 10 sends the starting clock information to synchronize with the recorded web content. The stored Web content is forwarded to the PC's browser with a playback clock initialized by the PVR 10. By utilizing the clock information, the PVR 10 allows the user to fast forward, stop, rewind, play slow motion, without losing the synchronization between the recorded TV program and the web content. Furthermore, deleting the stored broadcast program on the PVR 10 causes a signal to be sent to the PC 4 so it can delete the corresponding Web content.

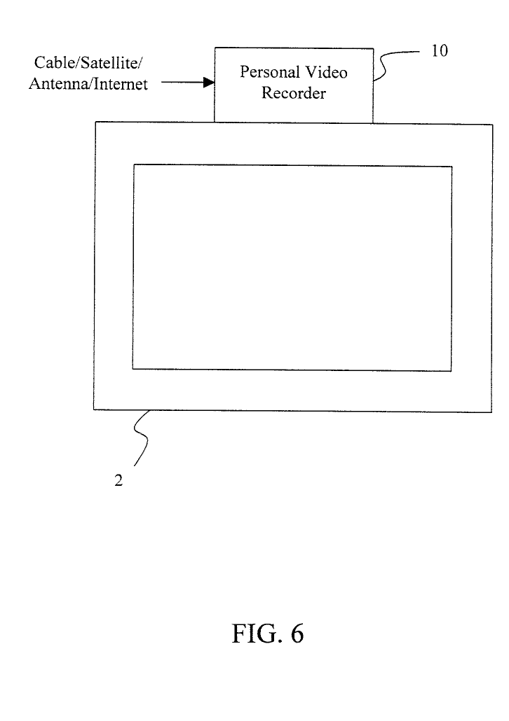

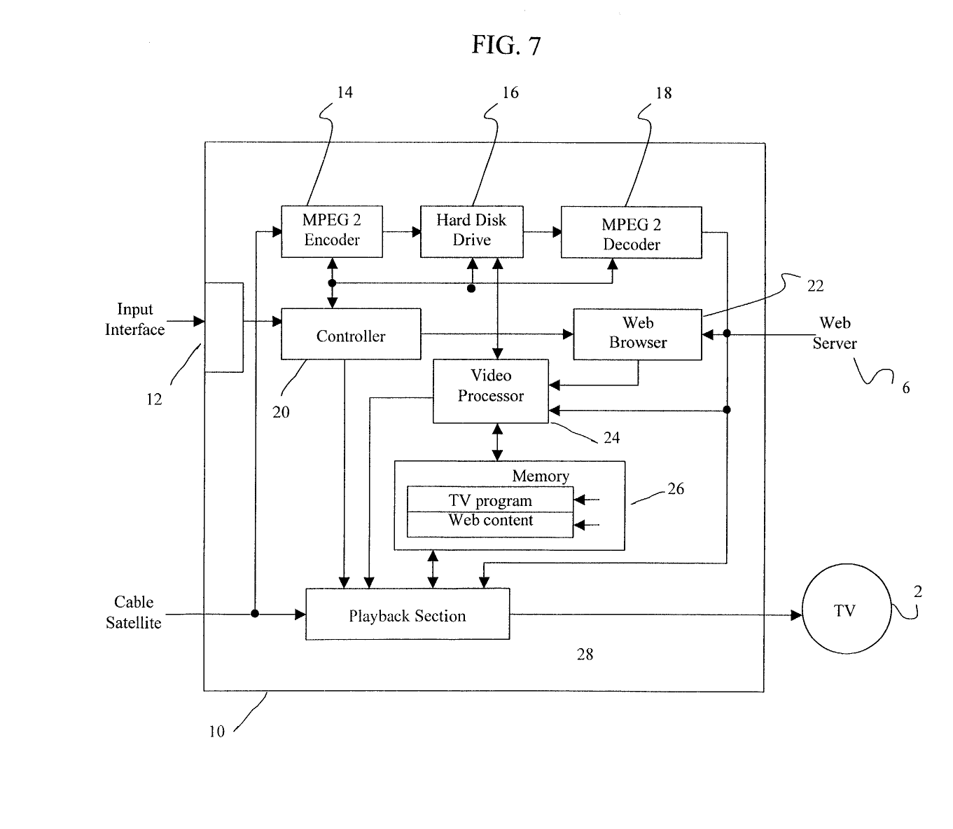

FIG. 6 illustrates a second embodiment of the present invention. In the second embodiment, the PVR 10 is coupled to receive both the incoming TV programs and the Internet content. As shown in FIG. 7, the PVR 10 includes an input interface (i.e., IR sensor) 12, MPEG-2 encoder 14, hard disk drive 16, MPEG-2 decoder, controller 20, web browser 22, video processor 24, and memory 26, and playback section 28. The controller 20 overseas the overall operation of the detection device 10, including a view mode, record mode, play mode, and other modes that are common in a personal video recording system. The construction and operation of the second embodiment are essentially the same as that described above with respect to FIG. 3, except that the PVR 10 further includes the web browser 22 for receiving the Internet content. Accordingly, the discussion of similar components and the function thereof described earlier are omitted to avoid redundancy, as they are described with respect to FIG. 3.

In the view mode, the controller 20 causes the incoming signals from the cable service provider to be demodulated and processed by the audio/video processor 24 for display on the television set 2. The video processor 24 tunes to a user-selected channel from incoming signals and converts the selected signal to a baseband television signal that is suitable for display on the television set 2. If the user makes a request to record a specific program along with the related web content, the controller 20 causes the portion of the program selected by the user from the TV broadcaster 8 to be stored in the memory 26. It is noted that a request to download the Internet content can be automatically triggered according to a well-known electronic program guide (EPG) protocol. At the same time, the controller 20 causes the web browser 22 to make a web connection and download the corresponding web information from the server, then stores the downloaded web content in the memory 26. Meanwhile, both sets of information are time stamped so that resynchronized displacing can be realized later. Hence, if a viewer wishes to play the recorded program along with the enhanced web simulcast, the controller 20 causes the playback section 28 to retrieve both the TV program and the synchronized web content from the memory 26. In this manner, the user can participate in the enhanced web features while watching the previously recorded TV program.

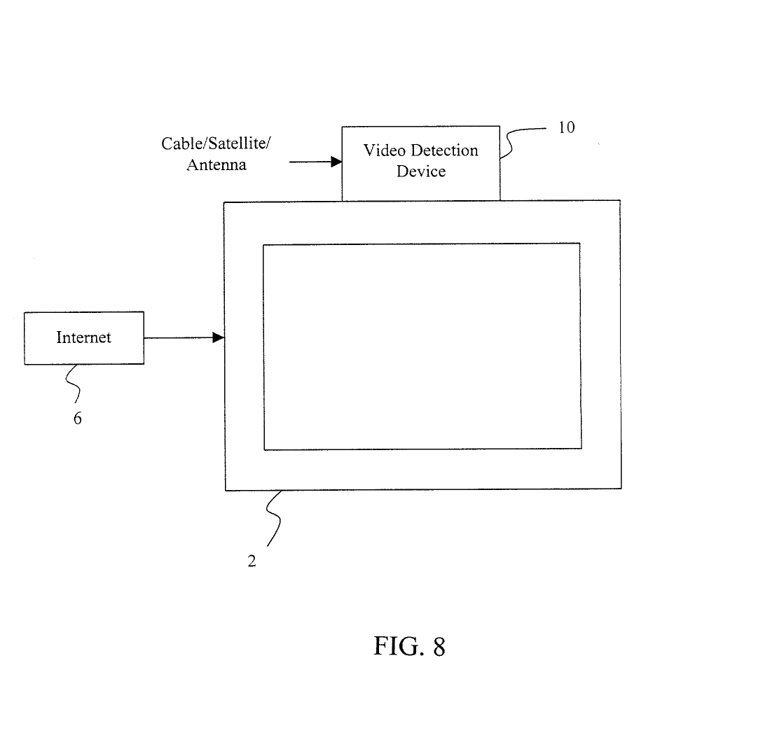

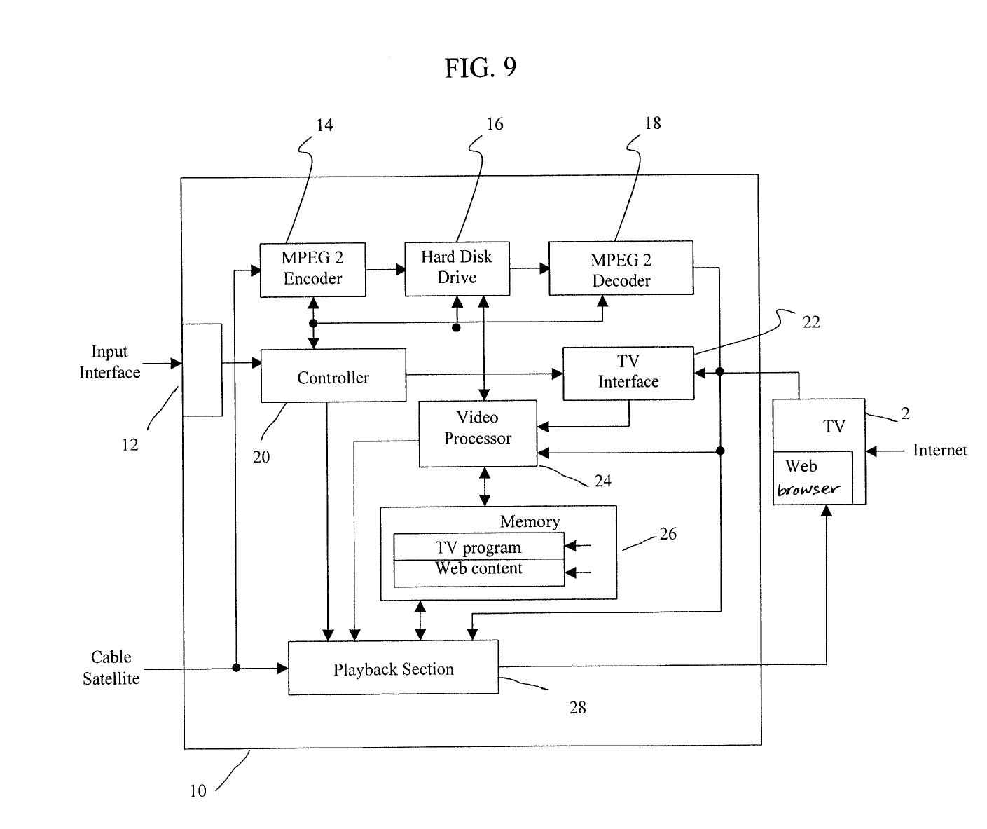

FIG. 8 illustrates a third embodiment of the present invention. In the third embodiment, the PVR 10 is coupled to receive the incoming TV programs, and a television set 2 in communication with the PVR 10 is coupled to receive the Internet content. Referring to FIG. 9, the PVR 10 includes an input interface (i.e., IR sensor) 12, MPEG-2 encoder 14, hard disk drive 16, MPEG-2 decoder, controller 20, TV interface 22, video processor 24, and memory 26, and playback section 28. The controller 20 oversees the overall operations of the detection device 10, including a view mode, record mode, play mode, and other modes that are common in a personal video recording system. Hence, the construction and operation of the third embodiment are essentially the same as that described above with respect to FIG. 7. The only notable difference is that the television set 2 with the web browser capability is coupled to receive the Internet content directly.

Upon receiving a request to store a program selected by a user, the controller 20 causes the selected program to be stored in the memory 26, and at the same time, causes the television set 2 to make a web connection and download the related web information, which is then stored in the memory 26 of the PVR 10. Here, both sets of information are time stamped so that a subsequent re-synchronization of them can be achieved for display. It should be noted that the PVR 10 can be programmed to automatically activate the television set 2 to download the Internet content based on a well-known electronic program guide (EPG) protocol. If the PVR 10 detects that a current incoming TV signal is simulcast with the “enhanced program”, the television is activated based on such a determination to download the corresponding web content. Thereafter, if a user wishes to play the recorded program, the controller 20 causes the playback section 28 to retrieve both the TV program and the corresponding Internet content from the memory 26.

Having thus described a preferred embodiment of a method and apparatus to record and replay a particular TV program and its related web simulcast content, it should be apparent to those skilled in the art that certain advantages of the system have been achieved. The foregoing is to be constructed as only being an illustrative embodiment of this invention. Persons skilled in the art can easily conceive of alternative arrangements providing a function similar to this embodiment without any deviation from the fundamental principles or the scope of this invention.

What is claimed is:

1. A method for recording a television program broadcast by a TV broadcaster, said method comprising the steps of:
receiving a request to record said television program selected by a user;
establishing a web connection to a web server of said TV broadcaster;
downloading the web content responsive to said television program; and,
storing said television program selected by said user and said downloaded web content from said web server in a memory.

2. The method of claim 1, further comprising the step of replaying said stored television program and the web content responsive to said television program in a synchronized manner.

3. The method of claim 2, wherein said replaying step further comprises the step of retrieving said stored television program and the corresponding said downloaded web content from said memory.

4. The method of claim 1, wherein said storing step further comprises a step of synchronizing said television program selected by said user with the web content of said web server responsive to said television program.

5. The method of claim 3, wherein said synchronization is achieved by time stamping said television program selected by said user and the web content that is responsive to said television program.

6. The method of claim 1, wherein said television program is received from the group consisting of cable, satellite, and antenna.

7. The method of claim 1, wherein said TV broadcaster includes a proxy or unaffiliated entity providing an interactive capability between said user and said web server of said TV broadcaster.

8. A method for providing a synchronized replay of a television program and the corresponding web content originated from a TV broadcaster's web server, said method comprising the steps of:
transmitting a request to record said television program via an input means;
automatically establishing a web connection to said web server of said TV broadcaster;
storing said television program and the web content of said web server responsive to said television program in a synchronized manner in a memory;
receiving a request to replay said stored television program via said input means; and,
replaying said stored television program and simultaneously displaying said stored web content that is responsive to said television program.

9. The method of claim 8, wherein said replaying step further comprises the step of retrieving said stored television program and the corresponding said downloaded web content from said memory.

10. The method of claim 8, wherein said synchronization is achieved by time stamping said television program selected by said user and the web content that is responsive to said television program.

11. The method of claim 8, wherein said television program is received from the group consisting of cable, satellite, and antenna.

12. The method of claim 8, wherein said TV broadcaster includes a proxy or unaffiliated entity providing an interactive capability between said user and said web server of said TV broadcaster.

13. An apparatus for providing a synchronized replay of a television program and the corresponding web content, comprising:
means for establishing a web connection to a web server displaying the corresponding web content;
means for recording said television program selected by a user;
means for storing said television program selected by said user and the corresponding web content;
means for reproducing said stored television program and the web content responsive to said television program in a synchronized manner; and,
a control means configured to receive a request to record said television program selected by said user, said control means controlling said recording means to initiate the recording of said television program and the web content that is responsive to said television program.

14. The apparatus of claim 13, further comprising a means for displaying said stored television program and the corresponding web content.

15. The apparatus of claim 13, further comprising a means for synchronizing said television program selected by said user with the web content responsive to said television program.

16. The apparatus of claim 13, wherein said synchronization is achieved by time stamping said television program selected by said user and the web content responsive to said television program.

17. The apparatus of claim 13, wherein said television program is received from the group consisting of cable, satellite, and antenna.
